(19) United States
(12) Patent Application Publication
(10) Pub. No.: US 2006/0049049 A1
(43) Pub. Date: Mar. 9, 2006

(54) Sensor element

(76) Inventors: Heiner Scheer, Berghuelen (DE); Frank Haag, Hussenhofen (DE); Ulrich Eisele, Stuttgart (DE); Lothar Diehl, Gerlingen (DE); Stefan Rodewald, Ditzingen (DE)

Correspondence Address: KENYON & KENYON, ONE BROADWAY, NEW YORK, NY, 10004, US

(21) Appl. No.: 10/524,627

(22) PCT Filed: Jul. 14, 2003
(86) PCT No.: PCT/DE03/02362

§ 371 Date: Feb. 2, 2005

(30) Foreign Application Priority Data
Aug. 3, 2002 (DE) 102 35 568.1

(51) Int. Cl. G01N 27/26

(52) U.S. Cl. 204/426; 204/427

(57) ABSTRACT

A layered sensor element used in particular for detecting a physical variable of a measuring gas, preferably for detecting the temperature of the measuring gas or the concentration of a gas component of the measuring gas. The sensor element contains a heater printed conductor situated in a layer plane of the sensor element, the heater printed conductor including a heater and a heater lead and being embedded in an insulation. In the layer plane of the heater printed conductor, the insulation is surrounded by a sealing frame at least in some areas. The extension of the sealing frame in the direction parallel to a layer plane of the sensor element and perpendicular to the longitudinal axis of the sensor element at least in some areas amounts to at least 25 percent, preferably 30 percent to 80 percent, of the extension of the sensor element in this direction.

### BACKGROUND INFORMATION

German Patent Application No. DE 198 34 276, for example, describes a sensor element. The planar, elongated sensor element contains an electrochemical cell having a first and a second electrode as well as a solid electrolyte located between the first and the second electrode. Furthermore, a wave-form heater having leads is provided, which is situated between two porous insulation layers of aluminum oxide. A sealing frame made primarily of zirconium oxide is attached around the insulation layers. The sealing frame extends to the outside surface of the sensor element and seals the insulation layers and the heater gas-tight.

Such sealing frames customarily have a width lying in the range of 10 percent to 15 percent of the total width of the sensor element. The width is understood here and in the following to be the extension (for example, of the sealing frame, insulation, or sensor element) in the direction parallel to the layer plane of the sensor element and perpendicular to the longitudinal axis of the sensor element. Furthermore, the width of the sealing frame is understood to be the total width, i.e., the total of the widths of the two segments of the sealing frame that are situated on both sides of the insulation layers.

For the manufacture of such sensor elements, solid electrolyte films in the unsintered state are printed with functional layers, i.e., with electrodes, protective layers, heater printed conductor, sealing frame, insulation layers, or layers of a pore-forming material. If necessary, hollow spaces, such as for example a reference gas space, are incorporated into a solid electrolyte film by stamping. The solid electrolyte films processed in such a way are subsequently laminated together by application of a laminating force and are then subjected to a sintering process.

The sensor elements are laminated together in one sheet and are then separated. Based on manufacturing tolerances in separating the sensor elements, the functional layers are not always exactly in the center of the sensor element after separating. Thus the width of the segment of the sealing frame on one side of the heater insulation may be smaller than the width of the segment of the sealing frame on the other side.

The sealing frame and the insulation layers display different sintering activities, which means that the sintering shrinkage and/or the temperature at which the sintering process starts are different. In an asymmetric sealing frame, the sensor element may become distorted during sintering due to the varying sintering activity. Such distorted sensor elements cannot be inserted in the provided mount of the gas sensor containing the sensor element.

Furthermore, German Patent Application No. DE 102 00 052 describes a sensor element in which a heater lead connected to a constant potential is situated in a layer plane between a second heater lead and a measuring device. As a result, the measuring device, for example, an electrochemical cell, is screened from the second heater lead by the first heater lead. A printed insulation layer is provided between the two heater leads.

### SUMMARY OF THE INVENTION

The sensor element according to the present invention has the advantage over the related art that a deviation from the setpoint when separating the sensor element results in a significantly lower distortion of the sensor element or none at all. Because the total width of the sealing frame amounts to at least 25% of the width of the sensor element, the width (with identical manufacturing tolerances) of the one segment of the sealing frame adjacent to the heater insulation differs from the width of the other segment of the sealing frame by a percentage amount that is significantly less than in the sensor elements known from the related art. Accordingly, the distortion of the sensor element resulting from the asymmetry of the two segments of the sealing frame is reduced.

Furthermore, the influence of the heater insulation, whose sintering activity differs from the sintering activity of the surrounding solid electrolyte films, on a distortion of the sensor element diminishes with a smaller distance of the heater insulation from the axis of symmetry and with a narrower width of the heater insulation in relation to the width of the sensor element.

The sensor element has a measuring area and a feed area. The measuring area of the sensor element is provided at the end segment of the sensor element exposed to the exhaust gas. Its extension is low in relation to the longitudinal extension of the sensor element. Situated in the measuring area are electrodes and a heater, for example, which are electrically connected to contact surfaces by leads which are situated in the feed area. The contact surfaces, which are situated on the end segment of the sensor element facing away from the measuring area, are electrically connected to conductor elements via which the sensor element is connected to an electronic evaluation unit located outside the gas sensor.

In order not to limit the extension of the electrical elements in the measuring area of the sensor element by a wide sealing frame, the width of the sealing frame in the measuring area of the sensor element may amount to less than 25 percent of the width of the sensor element. Since the longitudinal extension of the measuring area is considerably less than the longitudinal extension of the feed area, a distortion of the sensor element is also effectively reduced when the sealing frame has a width of at least 25% of the width of the sensor element only in the feed area. For manufacturing purposes, the distortion is reliably avoided in particular if the width of the sealing frame at least in the feed area lies in the range of 30 to 80 percent of the width of the sensor element.

The width of the sealing frame in the feed area may still be increased if the feeds are situated above each other in different plane levels of the sensor element and are separated from each other by, for example, a printed insulation layer.

In the measuring area, the sensor element has at least one electrochemical cell which has two electrodes and one solid electrolyte situated between the electrodes. Advantageously, the sealing frame contains a solid electrolyte and, with the heater printed conductor and the insulation surrounding the heater printed conductor, is situated between two solid electrolyte layers in order to ensure a good connection between the sealing frame, the solid electrolyte layers, and the solid electrolyte of the electrochemical cell.

In the area of the heater, high temperature differences arise, which may result in strong mechanical stresses in the insulation of the heater. If the insulation of the heater printed conductor is designed to be porous, the insulation is sufficiently elastic to avoid cracks in the insulation. In order to prevent the penetration of harmful gases into the insulation of the heater, the sealing frame has a lower porosity than the insulation and is preferably gas-tight. Advantageously, the sealing frame extends to the outside surface of the sensor element.

As its primary component, the sealing frame contains zirconium oxide stabilized by yttrium oxide. In order to adapt the sintering activity of the sealing frame to the insulation layers, the sealing frame contains an admixture of silicon oxide of 0.1 percent to 1.0 percent by weight, preferably 0.5 percent by weight.

### BRIEF DESCRIPTION OF THE DRAWINGS

FIG. 1 shows a cross section through a first exemplary embodiment of a sensor element according to the present invention along Line I-I in FIG. 2.

FIG. 2 shows a longitudinal section through the first exemplary embodiment along Line II-II in FIG. 1 and FIG. 3.

FIG. 3 shows a cross section through the first exemplary embodiment along Line III-III in FIG. 2.

FIG. 4 shows a longitudinal section through a second exemplary embodiment of a sensor element according to the present invention, FIG. 3 also showing a cross section through the second exemplary embodiment along Line III-III in FIG. 4.

FIG. 5 shows a cross section through a feed area of a third exemplary embodiment of a sensor element according to the present invention.

### DETAILED DESCRIPTION

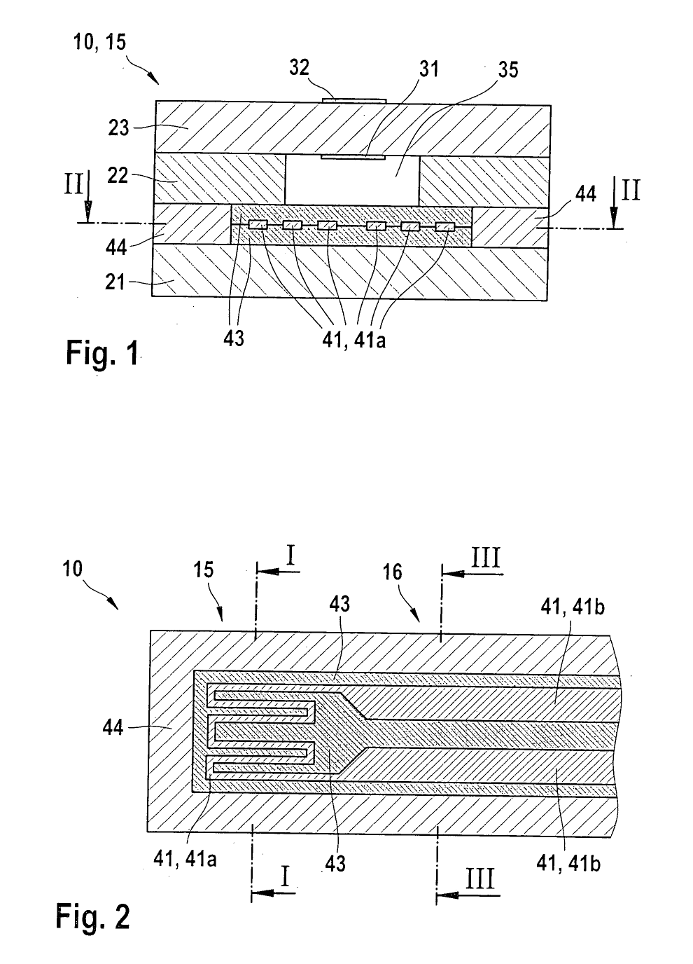

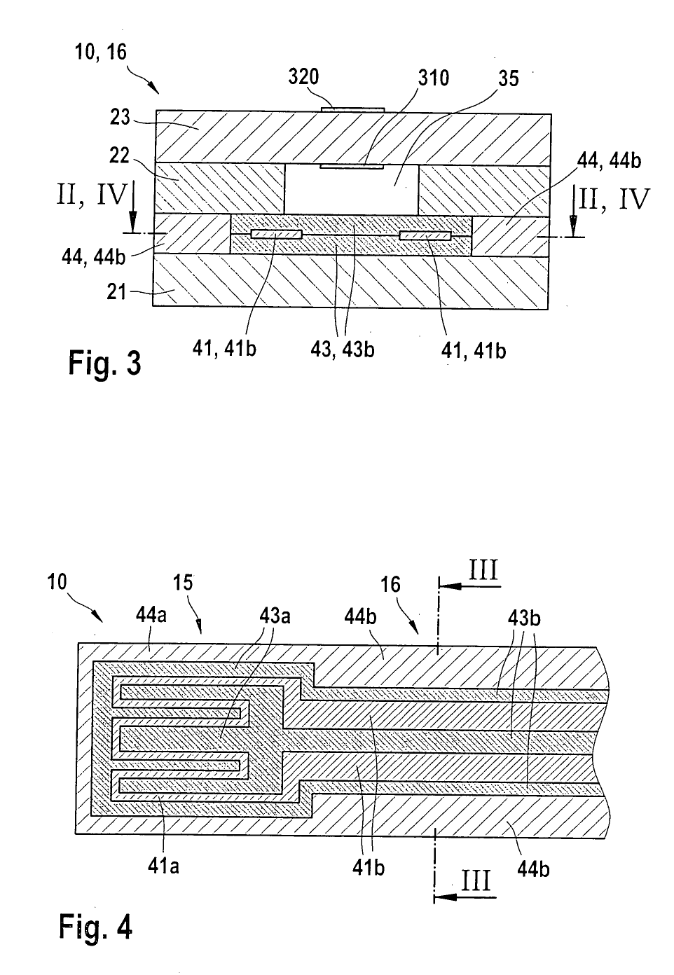

FIG. 1, FIG. 2 and FIG. 3 show a first exemplary embodiment of sensor element 10 according to the present invention. Sensor element 10 has a layered structure and contains a first solid electrolyte layer 21, a second solid electrolyte layer 22, and a third solid electrolyte layer 23. Sensor element 10 is installed in a gas sensor in the manner known to a person skilled in the art.

A heater printed conductor 41 having insulation 43 is provided between first and second solid electrolyte layer 21, 22. Insulation 43 is a porous layer of aluminum oxide which completely surrounds heater printed conductor 41. Insulation 43 of heater printed conductor 41 is surrounded laterally, i.e., in the layer plane of heater printed conductor 41, by a gas-tight sealing frame 44. Sealing frame 44 extends to the outside surface of sensor element 10.

Sealing frame 44 is primarily made of zirconium oxide which is stabilized by an yttrium oxide component in the range of 2.5 to 3.5 percent by weight and which contains an admixture of silicon oxide in the range of 0.1 percent to 1.0 percent by weight. Furthermore, aluminum oxide, preferably having a mean particle size of less than 0.1 μm as well as barium or fluorine as a flux, is added to sealing frame 44 for adapting the sintering activity to the surrounding elements.

A reference gas space 35 containing a reference gas is incorporated into second solid electrolyte layer 22. A first electrode 31 is applied to third solid electrolyte layer 23 in reference gas space 35. A second electrode 32 which is exposed to the exhaust gas and covered by a porous protective layer which is not shown is provided on the side of third solid electrolyte layer 23 which is opposite first electrode 31 and accordingly on an outside surface of sensor element 10. Together with solid electrolyte 23 situated between the two electrodes 31, 32, first and second electrodes 31, 32 form an electrochemical cell. If varying partial pressures of oxygen are present at first electrode 31 (in reference gas space 35) and at second electrode 32 (in the exhaust gas), a voltage is formed between the two electrodes 31, 32, which is a measure of the partial pressure of oxygen in the exhaust gas (Nernst cell). Electrochemical cell 31, 32, 23 is situated in a measuring area 15 of sensor element 10, i.e., on the end segment of sensor element 10 exposed to the exhaust gas.

Heater printed conductor 41 has a segment designed as a heater 41a. Another segment of heater printed conductor 41 is formed by two leads 41b. Heater 41a is provided in measuring area 15 of sensor element 10 and is used to heat the electrochemical cell. Via the two leads 41b, heater 41a is electrically connected to contact surfaces (not shown) which are provided on the end segment of sensor element 10 facing away from measuring area 15 on the outside surface of sensor element 10. Likewise, one lead 310, 320 leading to a contact surface is provided for each of the two electrodes 31, 32. The area of sensor element 10 which contains leads 41b of heater 41a and leads 310, 320 of electrodes 31, 32 is denoted as feed area 16 of sensor element 10. The longitudinal extension of feed area 16 (along the longitudinal axis of sensor element 10) is approximately two to three times as long as the longitudinal extension of measuring area 15.

Using a contacting device known per se, the contact surfaces are electrically contacted with conductor elements, via which the electrical elements (electrodes 31, 32 and heater 41a) are connected to an electronic evaluation unit situated outside of the gas sensor.

Sensor element 10 has a length of 6 cm, a width of 4 mm, and a height of 1.1 mm. The total width of the two segments of sealing frame 44, which surround both sides of insulation 43 and extend to the outer surface of sensor element 10, is 1.4 mm. In a symmetrically cut sensor element 10, the distance of insulation 43 from the outside surface of sensor element 10 and accordingly the width of a segment of sealing frame 44 is 0.7 mm. Thus the total width of sealing frame 44 is 35 percent of the width of sensor element 10.

In the first exemplary embodiment, the width of sealing frame 44 stays constant along the longitudinal axis of sensor element 10, i.e., in measuring area 15 (FIG. 1) and in feed area 16 (FIG. 3).

FIG. 4 shows a second exemplary embodiment of sensor element 10 according to the present invention which differs from the first exemplary embodiment in that sealing frame 44a in measuring area 15 has a lower width than sealing frame 44b in feed area 16. Accordingly, in the second exemplary embodiment, insulation 43a in measuring area 15 is wider than insulation 43b in feed area 16. Corresponding elements in the second exemplary embodiment are denoted using the same reference symbols as in the first exemplary embodiment.

In the second exemplary embodiment, the width of sealing frame 44a in measuring area 15 totals 0.8 mm; the width of sealing frame 44b in feed area 16 totals 1.4 mm as in the first exemplary embodiment. Since the width of sealing frame 44 in the first exemplary embodiment and the width of sealing frame 44b in feed area 16 of the second exemplary embodiment are not different, FIG. 3 shows a cross section through feed area 16 of the first and second exemplary embodiments of sensor element 10.

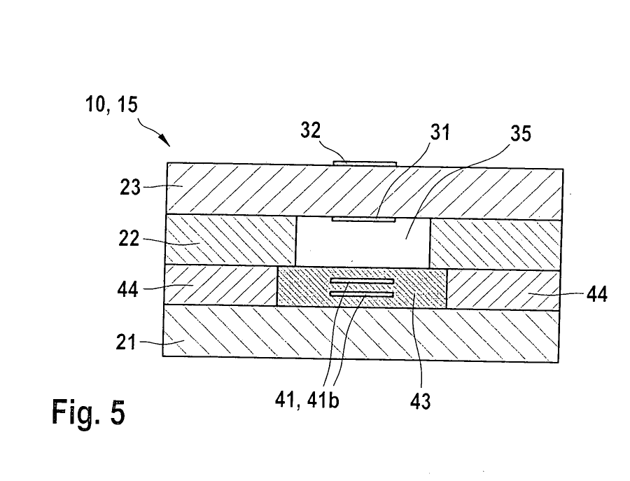

FIG. 5 shows a third exemplary embodiment of sensor element 10 according to the present invention. In the third exemplary embodiment, corresponding elements were denoted using the same reference symbols as in the first and second exemplary embodiments. In sensor element 10 according to the third exemplary embodiment, the heater leads 41b are situated in stacked layer planes and separated by a printed insulation layer. Thus insulation 43b in feed area 16 may be designed to be even narrower than in the first two exemplary embodiments. The width of insulation 43b in feed area 16 amounts to 1.8 mm. Accordingly, sealing frame 44b in feed area 16 has a total width of 2.2 mm, i.e., 55 percent of the width of entire sensor element 10. As in the second exemplary embodiment, sealing frame 44 is designed to be narrower in measuring area 15 than in feed area 16.

The present invention is not limited to the sensor type described in the exemplary embodiments but instead may be applied to other sensor types which have a heater printed conductor having insulation and surrounded by a sealing frame. In particular, the present invention may be applied to broadband lambda sensors or to sensors for detecting NOx, HC, CO, or other gas components of the exhaust gas of internal combustion engines.

1-11. (canceled)

12. A layered sensor element comprising:
an insulation;
a heater printed conductor situated in a layer plane of the sensor element, the heater printed conductor including a heater and a heater lead, the heater printed conductor being embedded in the insulation; and
a sealing frame surrounding the insulation in a layer plane of the heater printed conductor at least in some areas, wherein an extension of the sealing frame in a direction parallel to a layer plane of the sensor element and perpendicular to a longitudinal axis of the sensor element at least in some areas amounts to at least 25 percent of an extension of the sensor element in the direction.

13. The sensor element according to claim 12, wherein the sensor element is for detecting a physical variable of a measuring gas.

14. The sensor element according to claim 13, wherein the physical variable is a temperature.

15. The sensor element according to claim 13, wherein the physical variable is a concentration of a gas component.

16. The sensor element according to claim 12, wherein the extension of the sealing frame in the direction parallel to the layer plane of the sensor element and perpendicular to the longitudinal axis of the sensor element is in a range of 30 percent to 80 percent of the extension of the sensor element in the direction.

17. The sensor element according to claim 12, wherein the sealing frame has a solid electrolyte, zirconium oxide stabilized by yttrium oxide.

18. The sensor element according to claim 12, further comprising first and second solid electrolyte films, and wherein the sealing frame, the insulation, and the heater printed conductor are situated between the first and second solid electrolyte films, and the sealing frame surrounds the insulation and extends to an outside surface of the sensor element.

19. The sensor element according to claim 12, wherein the heater printed conductor has the heater in a measuring area of the sensor element, and the heater leads leading to the heater in a feed area of the sensor element.

20. The sensor element according to claim 19, wherein the extension of the sealing frame in the direction parallel to the layer plane of the sensor element and perpendicular to the longitudinal axis of the sensor element in the feed area amounts to at least 25 percent of the extension of the sensor element in the direction.

21. The sensor element according to claim 20, wherein the extension of the sealing frame in the direction in the feed area amounts to 30 percent to 80 percent of the extension of the sensor element in the direction.

22. The sensor element according to claim 12, wherein the heater printed conductor includes heater leads situated in different layer planes of the sensor element.

23. The sensor element according to claim 12, wherein at least one of (a) the insulation has a higher porosity than the sealing frame and (b) the sealing frame is gas-tight.

24. The sensor element according to claim 12, wherein a layer thickness of the sealing frame and the heater printed conductor having insulation is in a range of 52 μm to 74 μm.

25. The sensor element according to claim 24, wherein the layer thickness is 60 μm.

26. The sensor element according to claim 12, further comprising at least one electrochemical cell having a first electrode and a second electrode as well as a solid electrolyte situated between the first and the second electrode, a reference gas space, which contains a reference gas and in which the first electrode is situated, being situated in the sensor element.

27. The sensor element according to claim 12, wherein the sealing frame contains an admixture of silicon oxide of 0.1 percent to 1.0 percent by weight.

28. The sensor element according to claim 27, wherein the admixture of silicon oxide is 0.5 percent by weight.
